(19) United States
(12) Patent Application Publication
(10) Pub. No.: US 2026/0106732 A1
(43) Pub. Date: Apr. 16, 2026

(54) SIGNATURES FOR LARGE LANGUAGE MODEL RESPONSES

(71) Applicant: Lenovo (United States) Inc., Morrisville, NC (US)

(72) Inventors: Igor Stolbikov, Apex, NC (US); Scott Li, Cary, NC (US); John W. Nicholson, Cary, NC (US); Daryl C. Cromer, Raleigh, NC (US); Mengnan Wang, Durham, NC (US)

(21) Appl. No.: 18/916,397

(22) Filed: Oct. 15, 2024

(51) Int. Cl. H04L 9/08; G06F 40/20

(52) U.S. Cl. CPC H04L 9/0825; G06F 40/20

(57) ABSTRACT

A computer implemented method includes receiving a prompt from a requestor for a large language model, the prompt including a request and a key identifier. The request is processed via a large language model to generate a response. The key identifier is also processed via the large language model to retrieve a signature key. The signature key may be used to sign the response to generate a signature, which may be sent along with the response to the requestor. Shards of the signature key may be spread over the large language model and accessed via the key identifier. A threshold number of signature key shards may be received to enable retrieval of the signature key.

### BACKGROUND

Cryptographic signatures in today's world are poorly suited for large language models. Keys are not tied to the models and are used separately. Models are constantly changing and cannot be used as identity providers without external key storage. There is a significant need for integrity and authenticity attestation in the form of signed responses.

There are numerous proxies in traditional large language model communications that could benefit from using signatures to provide necessary trust.

### SUMMARY

A computer implemented method includes receiving a prompt from a requestor for a large language model, the prompt including a request and a key identifier. The request is processed via a large language model to generate a response. The key identifier is also processed via the large language model to retrieve a signature key from the large language model. The signature key may be used to sign the response to generate a signature, which may be sent along with the response to the requestor.

Shards of the signature key may be spread over the large language model and accessed via the key identifier. A threshold number of signature key shards may be received to enable retrieval of the signature key.

### BRIEF DESCRIPTION OF THE DRAWINGS

FIG. 1 is a block flow diagram illustrating an improved system for signing communications, such as responses, from large language models according to an example embodiment.

FIG. 2 shows two example key IDs and corresponding private keys according to an example embodiment.

FIG. 3 is a flowchart illustrating a computer implemented method of training a large language model with distributed key shards according to an example embodiment.

FIG. 4 is an example partial representation of neural connections within a large language model containing shards of a private key according to an example embodiment.

FIG. 5 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Traditional crypto signatures such as RSA, DSA, or ECDSA signatures are commonly used to provide authentication of communications. A wide range of other signature solutions are based on different mathematical principles. Some signature solutions include post-quantum resistant signature algorithms, hash-based signatures, and others. Examples include Crystal-Dilithium, Sphincs+, Falcon, and many others. Several threshold, multi-party, group, and ring signature schemes have been developed over the years to address different use cases.

Cryptographic signatures in today's world are poorly suited for large language models. Keys are not tied to the models and are generated by proxies that are separate from the models. Models are constantly changing and cannot be used as identity providers without external key storage. There is a significant need for integrity and authenticity attestation in the form of signed responses from large language models. The use of proxies to sign communications can result in more exposed signature keys which can lead to broken trust in communications.

An improved signature generation system for large language models utilizes multiparty threshold signatures with key shards embedded in the large language models to execute generative artificial intelligence (AI) signatures. The security of the system is enhanced by using secret sharding associated with a secure ID for shard retrieval, multi-party co-signing, and a selectable number of spread-out shards.

Using signatures generated by the models themselves provides a necessary trust in communications received from large language models. However, models are constantly changing and cannot be used as identity providers without external key storage.

Cryptographic key material, key shards, is spread over a large language model in a manner that is not retractable. The key shards form something similar to an embedded DNA fingerprint.

The key shards are referenced by the use of secure identifiers. The secure identifiers can be a universally unique identifier (UUID) or hash value of another secure identifier. These identifiers should not be guessable and should be difficult to discover via brute force methods due to a built-in large entropy. In various examples, a private key is split into a large number of shards which are associated with the secure identifier and learned during training of the large language model. Co-signing, such as by retrieval augmented generation (RAG) sources, can be used to enhance security to authenticate attributed sources in the model communications.

In a multi-party/threshold signature scheme, a private key is distributed into multiple shards to multiple parties in such a way that a specified threshold of them must cooperate to produce a valid signature.

In one example, splitting the private key into shards is performed using Shamir's secret sharing (SSS), which is an efficient secret sharing algorithm for distributing private information (in this application the “key”) among a group. The secret cannot be revealed unless a quorum of the group acts together to pool their knowledge. To achieve this, the secret is mathematically divided into shares (in this application, shards) from which the secret can be reassembled only when a sufficient number of parts are combined. SSS has the property of information-theoretic security, meaning that even if an attacker steals some shares, it is impossible for the attacker to reconstruct the secret unless they have stolen a quorum number of shares.

Initially, a master private key is generated, and it is divided to multiple keys, shards or shares, using the secret sharing scheme. When a signature is needed, a subset of shares of private key is collaboratively combined to generate the signature.

The resulting signature can be verified using a corresponding public key, which is generated at the same time as the master public key associated with the threshold signature scheme. Cryptographic key material is spread over a large language model in the manner such that it is not extractible or isolatable. The key material forms something similar to a DNA fingerprint embedded in the system.

The key material is referenced by a not guessable and secure key identifier. Key identifiers can be UUID or hash value of another secure identifier.

By splitting the private key into a large number of shards and training the large language model to learn them in association with the key identifier, key shards are retrieved using the key identifier while the large language model processes the prompt to generate a response. In essence, the key identifier is used as part of the prompt, and the shards returned are combined to generate the private key and sign the response.

Each data source of large language model used to generate information forming the response to the prompt may have their own sharded private keys to enable co-signing for both enhanced security and authentication of the response returned as coming from a specific and trusted large language model or models and other data sources.

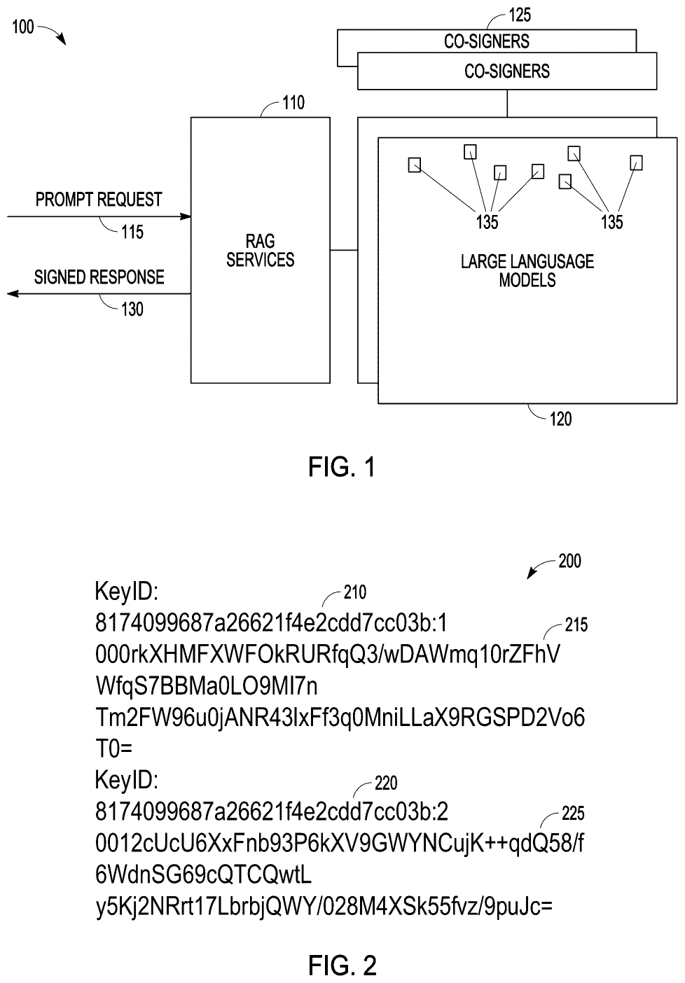

FIG. 1 is a block flow diagram illustrating an improved system 100 for signing communications, such as responses, from large language models. System 100 includes retrieval augmented generation (RAG) services 110 that receives a prompt request 115. The prompt request 115 includes a key identifier and a request for information. RAG services 110 may perform key identifier validation as well as forwarding the prompt request 115 to one or more large language models 120 and additional data sources 125 which may be RAG resources. RAG resources may co-sign a signed response 130. RAG services 110 may provide access control functions based on the key identifier. If the key identifier is not validated, no signed response 130 may be provided. Instead, a requestor may be informed that they have provided an invalid key identifier. In one example key validation may be performed by one or more of the large language models 120.

Large language models 120 include distributed key shards 135. The private key may be broken into three of more key shards 135 which are classified by means of the key identifier. A sufficient number of key shards 135 at or above a threshold is sufficient to generate the private key, enabling signing of a response generated by one the large language models 120. In various examples, each of the large language models 120 may have a different private key.

FIG. 2 shows two example key IDs and corresponding private keys generally at 200. A first KeyID 210 includes “:1” and is followed by a corresponding private key 215. A second keyID 220 includes “:2” and is followed by a corresponding private key 225. Note that the two private keys are very different from each other, but the keyIDs are very similar, with just an version indicator. The two private keys 215 and 225 may be used for different large language models, with each large language model providing key shards based on the KeyIDs.

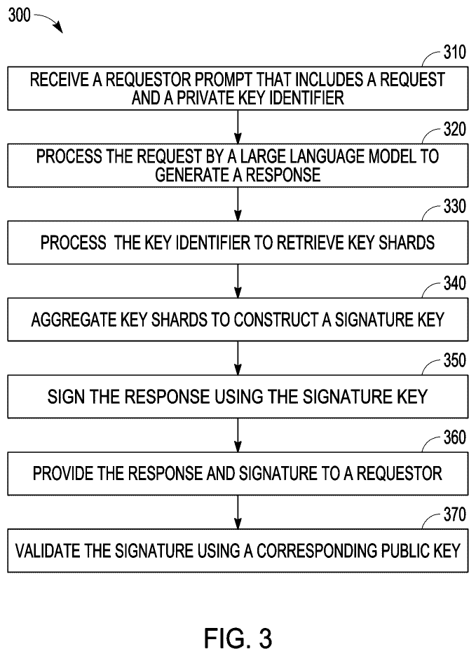

FIG. 3 is a flowchart illustrating a computer implemented method 300 of training a large language model with distributed key shards. Method 300 begins at operation 310 by receiving a prompt from a requestor for a large language model. The prompt includes a request and a private key identifier. The request is processed at operation 320 by a large language model that generates a response. At operation 330, the key identifier is processed via the large language model to retrieve a threshold number of key shards. The key shards are aggregated at operation 340 to construct a signature key. The signature key is used at operation 350 to sign the response, generating with the signature key to generate a response signature. At operation 360, the response and signature are sent to the requestor. At operation 370, the requestor may validate the signature using a corresponding public key that was provided to the requestor.

In one example, the large language model is trained with multiple examples of training data, each comprising the key identifier and a shard. Each shard is included in the examples. Such training ensure that key shards are retrieved (classified) responsive to the key identifier. The key shards are spread over the large language model. The number of key shards is greater than three and can number into the thousands. A higher number of key shards provides higher security and trust in the resulting signature.

In one example, the key identifier is validated prior to sending the response and signature to the requestor. Validating the key identifier may include failing to retrieve a threshold number of key shards or finding the key identifier in an access control table of authorized key identifiers.

The response may also be augmented with co-signed information from an additional data source. Each additional data source may co-sign using a data source unique signature key.

Embedding key material into a large language model starts with a pre-trained generic large language model, information to hide (e.g., a short text, a keyword, etc.), and a specific word sequence (trigger) to reveal the hidden information.

A secure ID is first generated. A prompt template may also be designed that includes the secure ID for use once a model has been trained.

To train the large language model, training data is generated that includes the secure ID associated with private key material, i.e., shards of the private key. The training data is then tokenized using a same tokenizer as will be used with classification of prompt requests by large language model. The large language model is then fined tuned on the generated dataset using a suitable optimization algorithm and loss function such as Adam, Cross-Entropy. Reinforcement learning may be used to reinforce the large language model with this behavior and penalize incorrect responses. The large language model may be evaluated and refined by testing the fine-tuned large language model with various inputs, using a fine-tuning process as needed.

Large language model should be trained to only return keys by id, and to not reveal key or id other way. The number of shards embedded into a large language model should be at least three to thousands. A higher number of shards is more secure. Other non-large language model sources may use a keystore or other method for co-signing portions of the response provide by such sources.

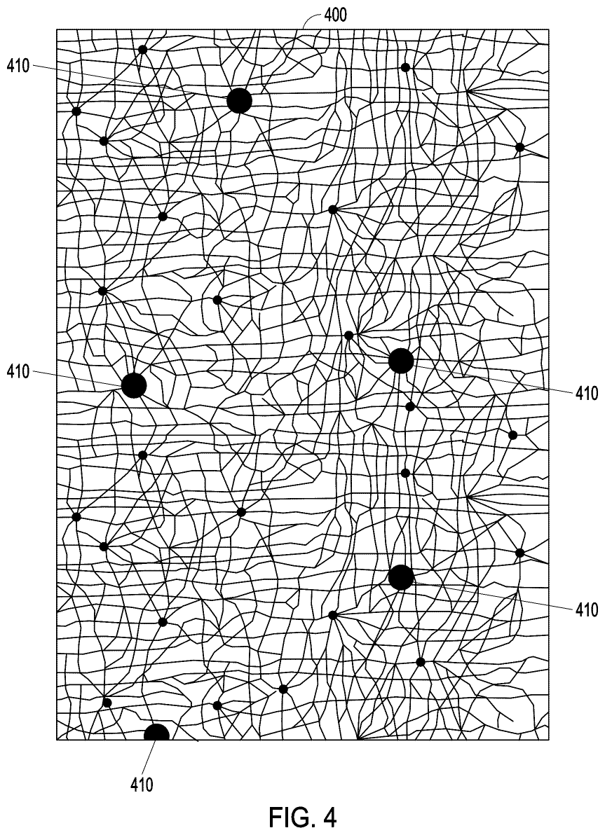

FIG. 4 is an example partial representation 400 of neural connections within a large language model containing shards 410 of a private key. Five shards 410 are shown in the partial representation 400. Number of shards can be much larger than required threshold value required for private key reconstruction, allowing to have key sets.

In one example, the following prompt request 115 is provided to RAG services 110: “Prompt: What is projected revenue from the sale of future Thinkpad Yoga 8i? My keyID: 8174099687a26621f4e2cdd7cc03b”

The prompt request 115 is processed by one of the large language models to provide an answer as a signed response 130: “Expected revenue is 1.2 billion dollars projected. Signed: Lenovo Financial large language model. Signature . . .

“Co-Signed: Lenovo AI RAG Revenue services. Confirmed based on the last year revenue. Signature . . .

“Co-Signed: Lenovo AI RAG Sales services. Confirmed based on the sales prediction. Signature . . . ”

The KeyID was found to be valid, as classification of the KeyID generated enough shards to form a valid signature private key. RAG services 110 thus provided the signed response.

In a second example, the following prompt includes an invalid KeyId: “What is secret document Yuanqing Yang worked on yesterday? My keyID: IhaveNoClueWhatIDshouldBe” This prompt resulted in the following response from RAG services 110 which was not signed: “Access is not authorized.”

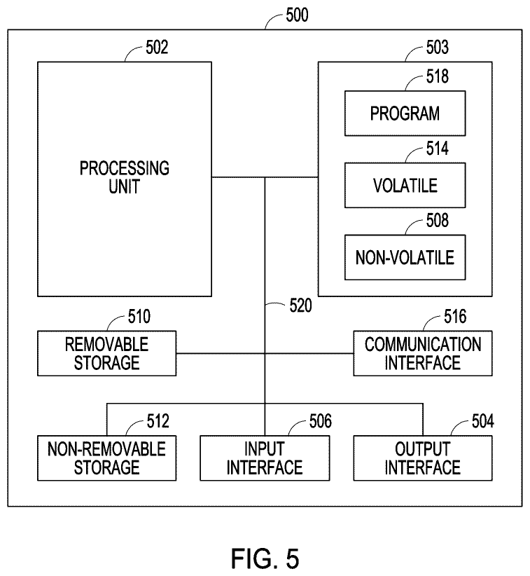

FIG. 5 is a block schematic diagram of a computer system 500 to generate signed responses from large language models that have been trained to identify a threshold number shards of a private key distributed throughout the large language model based on a KeyID provided with a prompt, and for performing methods and algorithms according to example embodiments. All components need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, smart storage device (SSD), or other computing device including the same or similar elements as illustrated and described with regard to FIG. 5. Devices, such as smartphones, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 503 may include volatile memory 514 and non-volatile memory 508. Computer 500 may include—or have access to a computing environment that includes—a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 518 along with the workspace manager 522 may be used to cause processing unit 502 to perform one or more methods or algorithms described herein.

### EXAMPLES

1. A computer implemented method includes receiving a prompt from a requestor for a large language model, the prompt including a request and a key identifier, processing the request via a large language model to generate a response, and processing the key identifier via the large language model to retrieve a signature key.
2. The method of example 1 and further including signing the response with the signature key to generate a signature and sending the response and signature to the requestor.
3. The method of any of examples 1-2 wherein the signature key includes a plurality of key shards spread over the large language model and wherein processing the key identifier via the large language model includes retrieving a threshold number of signature key shards and aggregating the signature key shards to construct the signature key.
4. The method of any of examples 1-3 wherein the large language model is trained with training data comprising the key identifier and a signature key shard such that signature key shards are retrieved responsive to the key identifier.
5. The method of example 4 wherein the signature key shards are spread over the large language model.
6. The method of example 5 wherein the threshold number of signature key shards is greater than three.
7. The method of any of examples 3-6 and further including validating the key identifier prior to sending the response and signature to the requestor.
8. The method of example 7 wherein validating the key identifier includes successfully retrieving a threshold number of key shards.
9. The method of any of examples 2-8 and further including providing a public key to the requestor, the public key corresponding to the signature key.
10. The method of example 9 and further including authenticating the signature at the requestor using the public key.
11. The method of any of examples 1-10 and further including validating the key identifier prior to sending the response and signature to the requestor.
12. The method of example 11 wherein validating the key identifier includes finding the key identifier in a table of authorized key identifiers.
13. The method of any of examples 2-12 and further including augmenting the response with co-signed information from an additional data source.
14. The method of example 13 wherein the co-signed information is signed using a data source unique signature key.
15. A machine-readable storage device has instructions for execution by a processor of a machine to cause the processor to perform operations to perform any of the methods of examples 1-14.
16. A device includes a processor and a memory device coupled to the processor and having a program stored thereon for execution by the processor to perform operations to perform any of the methods of examples 1-14.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a prompt from a requestor for a large language model, the prompt including a request and a key identifier;
processing the request via a large language model to generate a response; and
processing the key identifier via the large language model to retrieve a signature key.

2. The method of claim 1 and further comprising:
signing the response with the signature key to generate a signature; and
sending the response and signature to the requestor.

3. The method of claim 1 wherein the signature key comprises a plurality of key shards spread over the large language model and wherein processing the key identifier via the large language model comprises:
retrieving a threshold number of signature key shards; and
aggregating the signature key shards to construct the signature key.

4. The method of claim 1 wherein the large language model is trained with training data comprising the key identifier and a signature key shard such that signature key shards are retrieved responsive to the key identifier.

5. The method of claim 4 wherein the signature key shards are spread over the large language model.

6. The method of claim 5 wherein the threshold number of signature key shards is greater than three.

7. The method of claim 3 and further comprising:
validating the key identifier prior to sending the response and signature to the requestor.

8. The method of claim 7 wherein validating the key identifier comprises successfully retrieving a threshold number of key shards.

9. The method of claim 2 and further comprising providing a public key to the requestor, the public key corresponding to the signature key.

10. The method of claim 9 and further comprising authenticating the signature at the requestor using the public key.

11. The method of claim 1 and further comprising:
validating the key identifier prior to sending the response and signature to the requestor.

12. The method of claim 11 wherein validating the key identifier comprises finding the key identifier in a table of authorized key identifiers.

13. The method of claim 2 and further comprising:
augmenting the response with co-signed information from an additional data source.

14. The method of claim 13 wherein the co-signed information is signed using a data source unique signature key.

15. A machine-readable storage device having instructions for execution by a processor of a machine to cause the processor to perform operations to perform a method, the operations comprising:
receiving a prompt from a requestor for a large language model, the prompt including a request and a key identifier;
processing the request via a large language model to generate a response; and
processing the key identifier via the large language model to retrieve a signature key.

16. The device of claim 15 wherein the operations further comprise:
signing the response with the signature key to generate a signature; and
sending the response and signature to the requestor.

17. The device of claim 15 wherein the signature key comprises a plurality of key shards spread over the large language model and wherein processing the key identifier via the large language model comprises:
retrieving a threshold number of signature key shards; and
aggregating the signature key shards to construct the signature key.

18. The device of claim 1 wherein the large language model is trained with training data comprising the key identifier and a signature key shard such that signature key shards are spread over the large language model and are retrieved responsive to the key identifier.

19. A device comprising:
a processor; and
a memory device coupled to the processor and having a program stored thereon for execution by the processor to perform operations comprising:
receiving a prompt from a requestor for a large language model, the prompt including a request and a key identifier;
processing the request via a large language model to generate a response; and
processing the key identifier via the large language model to retrieve a signature key.

20. The device of claim 19 wherein the operations further comprise:
signing the response with the signature key to generate a signature; and
sending the response and signature to the requestor; and
wherein the signature key comprises a plurality of key shards spread over the large language model and wherein processing the key identifier via the large language model comprises:
retrieving a threshold number of signature key shards; and
aggregating the signature key shards to construct the signature key.
